(19) United States
(12) Patent Application Publication
(10) Pub. No.: US 2006/0170714 A1
(43) Pub. Date: Aug. 3, 2006

(54) Ultrasound diagnosis apparatus and ultrasound data generating method

(75) Inventor: Ryoichi Kanda, Tochigi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA TOSHIBA, Minato-ku (JP); TOSHIBA MEDICAL SYSTEMS CORPORATION, Otawara-shi (JP)

(21) Appl. No.: 11/333,512

(22) Filed: Jan. 18, 2006

(30) Foreign Application Priority Data
Jan. 18, 2005 (JP) 2005-009900

(51) Int. Cl. G01D 9/00

(52) U.S. Cl. 346/2

(57) ABSTRACT

An ultrasound diagnostic apparatus and an ultrasound data generating method that can display a plurality of stress image data. The stress image data are generated under a plurality of different conditions of stress, and reference image data corresponding to each of the stress image data is obtained to perform a comparison display. The reference image data is acquired by suspending a stress image data collecting mode for the stress image data. The ultrasound diagnostic apparatus and ultrasound data generating method store stress image data that are generated with a predetermined data collecting protocol, i.e., stress conditions and image cross-section. The generation of the stress image data is suspended by inputting a suspend command supplied through an input unit in order to generate reference image data in another image collecting mode. The reference image data generated during the suspension of the predetermined data collecting protocol are stored in the same storage unit with added index data regarding the stress data collecting protocol in order to display each reference image data in correspondence with each of the stress images.

### CROSS-REFERENCE TO RELATED APPLICATIONS

This application claims priority from, and the benefit of, Japanese Patent Application No. 2005-9900, filed on Jan. 18, 2005, the contents of which are expressly incorporated herein by reference in their entirety.

### BACKGROUND OF THE INVENTION

A. Field of the Invention

The present invention relates to an ultrasound diagnosis apparatus and an ultrasound data generating method that have a special mode for collecting images for performing stress echography for which some stress is given to an object (a patient), and more particularly to an ultrasound diagnosis apparatus and an ultrasound data generating method that have functions for suspending and returning the collecting mode of the stress image data.

B. Background of the Invention

An ultrasound diagnosis apparatus transmits ultrasound through ultrasound transducers installed in an ultrasound probe to a patient' body and receives reflected or distributed ultrasound from the patient's body so as to display an organ structure or living body's data from blood cells in the patient's body as images on a monitor in the ultrasound diagnosis apparatus. Since an ultrasound diagnostic apparatus can easily obtain motion images in a real time, it is widely used as a diagnosis apparatus that is selected in the first priority to diagnose functions of a heart in a patient's body.

To diagnose functions of a heart by using an ultrasound diagnosis, a stress echo inspection (echography) is widely applied in which some stress of motion or a medicine is given to a patient's body in order to observe changes or variations of cardiac muscles of the heart in accordance with an amount of the given stress. In an ultrasound diagnosis apparatus for performing the stress echo inspection, there is a specialized mode for collecting a plurality of B mode images and for displaying the plurality of collected B mode images on a monitor in order to efficiently observe or evaluating the images. The collected B mode images are graded black and white images, and are based on a predetermined stress echo protocol by changing the amount of the stress that is used. Hereinafter, such a specialized mode of image data collection and displaying for an observation is called as a stress echo package (SEP).

A predetermined collecting protocol for SEP is comprised of a “phase” and a “view”. A “phase” defines a volume of the given stress to an object, and a “view” defines a tomography image that is collected at each of the different “phases”. Thus, B mode images are collected by a data collecting sequence that is comprised of each different “phase” and several “views”

For instance, in a case of the stress echo inspection by using a medicine such as the “Dobtamine,” a collecting protocol is combined so as that the amount of “phases” are defined as the four stages of “0 gamma (no stress)”, “10 gamma”, “20 gamma”, and “40 gamma”. Four different tomography images, obtained at each of the four stages of the “phases,” are defined as a “short axis image”, a “long axis image”, a “four ventricles image” and a “two ventricles image”, respectively. Of course, it is possible to define other different stages of “phase” and “view” than the above-explained stages.

In general, image data being collected under these data collecting protocols of “phases” and “views” are displayed as B mode image data in an appropriate format so as that it is possible to easily perform observation or inspection by comparing a plurality of image data. For instance, four kinds of the “short axis images” that are collected at each of the four “phases” are displayed on the same monitor for a display unit of an ultrasound diagnosis apparatus. Thus, by displaying a plurality of the collected image of different “phases” in the same monitor, it becomes possible for a doctor or an inspector (hereinafter referred to as an operator) to precisely observe and to differentiate cardiac motions of the object.

Recently, during the stress echo inspection, it is strongly desired to display B mode images and also to display reference data, such as color data of Doppler mode, a TDI (Tissue Doppler Imaging) mode, or raw data and measured data that are acquired by using other various modes, in order to display reference data in connection to the B mode image.

Japanese Patent Application Publication 6-285066 proposes a method for evaluating cardiac function of an object by calculating a difference or a ratio of a motion speed of a cardiac wall before applying a stress, and a motion speed of the cardiac wall after applying a stress. The motion speed is obtained by Doppler components of receiving signals reflected from cardiac walls through ultrasound transmission and reception. The obtained Doppler components of signals, which are reflected, generate Doppler images.

To achieve the above-noted results during the collection of B mode images, a prescribed collecting protocol for B mode image is suspended once in order to return the ultrasound apparatus to a normal stage and to change the apparatus to a desired mode for collecting other images or data. After finishing the acquisition under the desired mode, the B mode image collection mode is restarted. By turning a suspension switch on, the apparatus goes to a normal stage in that the apparatus can be freely operated. By turning the suspension switch off, again the apparatus goes back to image collection mode under the prescribed stress image collecting protocol.

However, when a prescribed stress image collecting protocol is suspended in order to return to a normal mode of the apparatus, it is impossible to determine whether the images or data collected during the suspension are collected under “phase” or “view”. Since no information as to “phase” and “view” is obtained during the suspension, it is impossible to determine how the images or data correspond with the acquired stress image. For a stress echo inspection, it is important to know what data is acquired at what “phase.” If data is acquired under stress echo collecting mode, in a speculation mode of SEP, as explained above, it is possible to display image or data at the most appropriate layout. However, it is impossible to display the images or data generated by the other mode during the suspension, since no information as to the acquired “phase” is given.

### SUMMARY OF THE INVENTION

An object of the present invention is to solve the above-noted problems. Thus, the present invention provides a novel ultrasound diagnostic apparatus and an ultrasound data generating method that can display various data that are acquired during a suspension of a stress echo protocol by an observation mode of SEP. To do so, the data acquired during a suspension of a stress echo protocol are stored with affixed index data regarding the suspended stress echo protocol. Thus, the acquired reference data, such as reference image data, raw data or measuring data, are able to be displayed in the conservation mode of SEP.

To achieve these purposes, an embodiment of the present invention provides an ultrasound diagnostic apparatus for transmitting and receiving ultrasound to and from an object being given a stress, the apparatus having a special mode for collecting received data from the stressed object based on a prescribed collecting protocol. Thus, the ultrasound diagnostic apparatus includes: a control unit configured to control the transmission and reception of ultrasound and to control a collecting and displaying sequence for a plurality of stress image data that are acquired based on a plurality of different conditions of the stress; a first storage area configured to store the plurality of stress image data collected based on the prescribed collecting protocol at a first predetermined position; an input unit configured to input an interrupt command for suspending the collecting and displaying sequence based on the prescribed collecting protocol and to input a return command for restarting the suspended collecting and displaying sequence; a reference data generating unit configured to collect reference data based on another data collecting mode that is different from the prescribed collecting protocol by using the received data collected during the suspension of the collecting and displaying sequence; a second storage area configured to store the reference data with added index data regarding the prescribed collecting protocol at a second predetermined position under control by the control unit; and a display unit configured to display a reconstructed stress image and corresponding reference data under control of the control unit, the corresponding reference data is displayed by using the index data added to each of the reference data.

Another embodiment of the present invention provides a new ultrasound data generating apparatus for transmitting and receiving ultrasound to and from an object being given a stress. The ultrasound data generating apparatus includes: a control unit configured to control generation of a plurality of ultrasound data that are acquired under a plurality of different conditions of the stress based on a prescribed protocol; and a data storage unit configured to store ultrasonic data collected between a suspension and a return of the prescribed protocol so as to correspond with data regarding the prescribed protocol at a time of the suspension.

Another embodiment of the present invention provides an ultrasound data generating apparatus for generating ultrasound images of an object by transmitting and receiving ultrasound to and from a stressed object, the data generating apparatus includes: a stress image generating unit configured to generate a plurality of different stress images based on a prescribed protocol; a reference data generating unit configured to generate a plurality of reference data in a different mode from the prescribed protocol; a display unit configured to display the stress image and the reference data; a controller configured to control the stress image generating unit, the reference data generating unit and the display unit; an operating unit configured to suspend and to return the prescribed protocol; and a data storage unit configured to store ultrasound images that are collected during a period between the suspension of the prescribed protocol and the restart the prescribed protocol in correspondence with data regarding the prescribed protocol at a suspended time.

Furthers another embodiment of the present invention provides an ultrasound data generating method for generating ultrasound images of an object by transmitting and receiving ultrasound to and from a stressed object, the ultrasound data generating method includes steps of: generating a plurality of different stress images based on a prescribed protocol; generating a plurality of reference data in a different mode from the prescribed protocol; displaying the stress image and the reference data; controlling the stress image generation, the reference data generation and the display; suspending and returning the prescribed protocol; and storing ultrasound images that are collected during a period between the suspension of the prescribed protocol and restarting of the prescribed protocol in correspondence with data regarding the prescribed protocol at a suspended time.

According to another embodiment of the present invention, the image data, raw data and measured data that are collected during a suspension of image collecting mode based on a stress echo protocol are stored with added index data. The index data includes data indicating that an image is acquired during a suspension of an image collecting mode under a stress echo protocol, data indicating stress echo inspection, and data regarding “phase” and “view” that are just before entering the suspension. Consequently, during an inspection mode of the stress echo images, it becomes possible to display a reconstructed image by using an appropriate reference data indicated by an added index data. Thus, the apparatus and method according to the present invention can largely improve accuracy and efficiency of diagnosis of a stress echography.

### BRIEF DESCRIPTION OF THE DRAWINGS

The accompanying drawings, which are incorporated in and constitute part of this specification, illustrate various embodiments and/or features of the present invention, and together with the description, serve to explain embodiments of the present invention. Where possible, the same reference number will be used throughout the drawings to describe the same or like parts. In the drawings:

FIG. 1 is a block diagram illustrating an ultrasound diagnostic apparatus of a first embodiment according to the present invention.

FIG. 2 is a block diagram illustrating a transmitting/receiving unit and a data generating unit shown in FIG. 1.

FIG. 3 depict various image data areas stored in a data memory of the unit shown in FIG. 1.

FIG. 4 shows practical examples of stress echo protocols stored in a memory circuit in a system control unit shown in FIG. 1.

FIG. 5 is a flowchart explaining a process for generating a stress image data and a reference image data used in the embodiment shown in FIG. 1.

FIG. 6 is a flowchart representing a process for performing comparison display of stress image data used in the embodiment illustrated in FIG. 1.

FIG. 7 show a practical example of an image data list displayed in a display unit of the embodiment shown in FIG. 1.

FIG. 8 shows an example of stress image data displayed in the display unit depicted in FIG. 1.

FIG. 9 show a practical reference image data list displayed in the display unit of the embodiment shown in FIG. 1.

### DESCRIPTION OF THE EMBODIMENTS

With reference to the drawings, the embodiments of an ultrasound diagnosis apparatus and method, and an ultrasound data generating apparatus and method consistent with the present invention are explained. In this explanation, B mode image data being collected based on a stress echo protocol is simply referred to as “stress image data,” and an organ Doppler image and blood stream Doppler image that are collected under the same stress echo protocol are referred to as “reference organ Doppler image” and “reference blood stream Doppler image”, respectively. Further, the reference organ Doppler image and the reference blood stream Doppler image are totally referred to as “reference image data”.

The ultrasound diagnostic apparatus and the ultrasound data generating apparatus, consistent with the present invention, generate and store stress image data under prescribed data collecting protocols, e.g. a “phase” and a “view”, based on a preliminarily determined stress echo protocol. Further, the ultrasound diagnostic apparatus of the present invention stores reference image data in the data collecting protocol that is obtained by interrupting generation of the stress image data during storage of the stress image data. The reference image data is stored together with the protocol data. When the stored stress image data are read in order to perform a comparison among different “phases,” the reference image data corresponding to each stress image data are read based on annexed protocol data and are displayed.

The embodiment of ultrasound diagnostic apparatus and ultrasound data generating method consistent with the present invention can display each reference data in an observation mode of SEP based on each index data that is affixed to each of the reference data. Further, it is possible to display a list of all reference data acquired during a suspension of a stress echo inspection by pushing a switch for displaying related data. The list is classified by items, such as, “phase”, “view”, kinds of data, e.g., image data, raw data, measured data, and an image mode at that time when the data is acquired. It is possible to display a list of each classified item. For example, it is possible to display a list of image modes by selecting an item of “kind of data” in order to display by constructing a “phase” of top priority of the classification followed by a “view”.

Further, according to the ultrasound diagnostic apparatus and ultrasound data generating method consistent with the present invention, it is possible to display each data in an appropriate format by clicking index data that are displayed in a list. Thus, usual data can be displayed as a normal usage of the ultrasound diagnostic apparatus. Data of a special format, such as raw data, are displayed by driving special software for displaying such data. In the following embodiments of the present invention, it is assumed that data collection during a stress echo inspection is achieved in an ultrasound diagnostic apparatus itself and an observation of B mode data and an inspection are performed on a monitor of a workstation. On icon menus of the workstation, each of the B mode images acquired in SEP are collectively displayed with one icon, and each data acquired during a suspension of the stress image protocol is each displayed by icons or thumbnails, respectively. Accordingly, it is possible to display each data that is acquired during a suspension. B mode images that are collected in SEP can be displayed in an observation mode by clicking an icon for SEP in order to drive the SEP. At this time, since a list of data acquired during a suspension is displayed, it becomes possible to display reference data for each of the classified items by clicking a switch for selecting reference data.

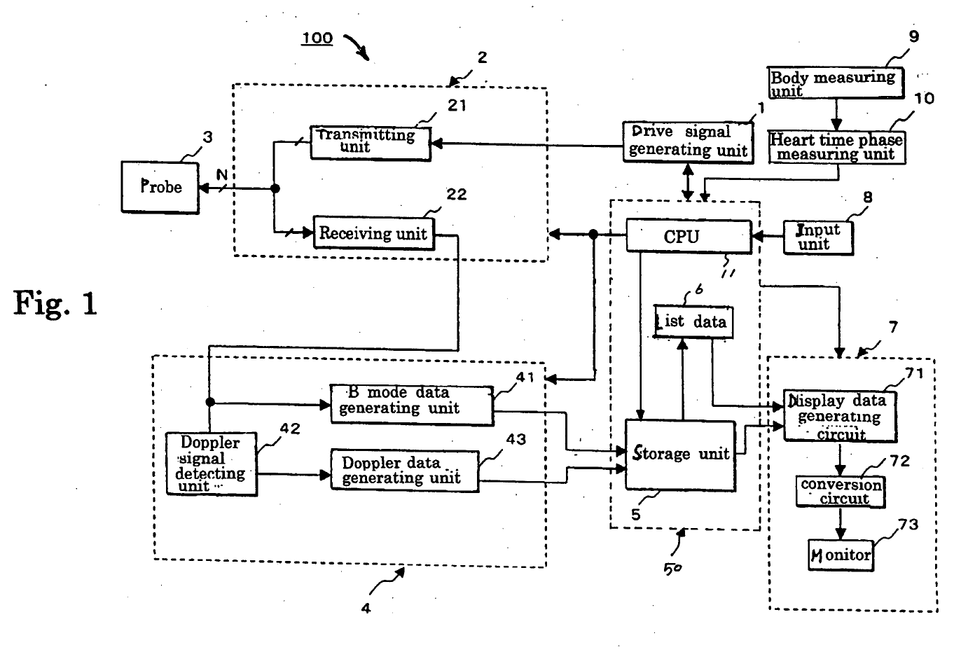

FIG. 1 is a block diagram for illustrating an entire construction of an embodiment of the ultrasound diagnostic apparatus consistent with the present invention.

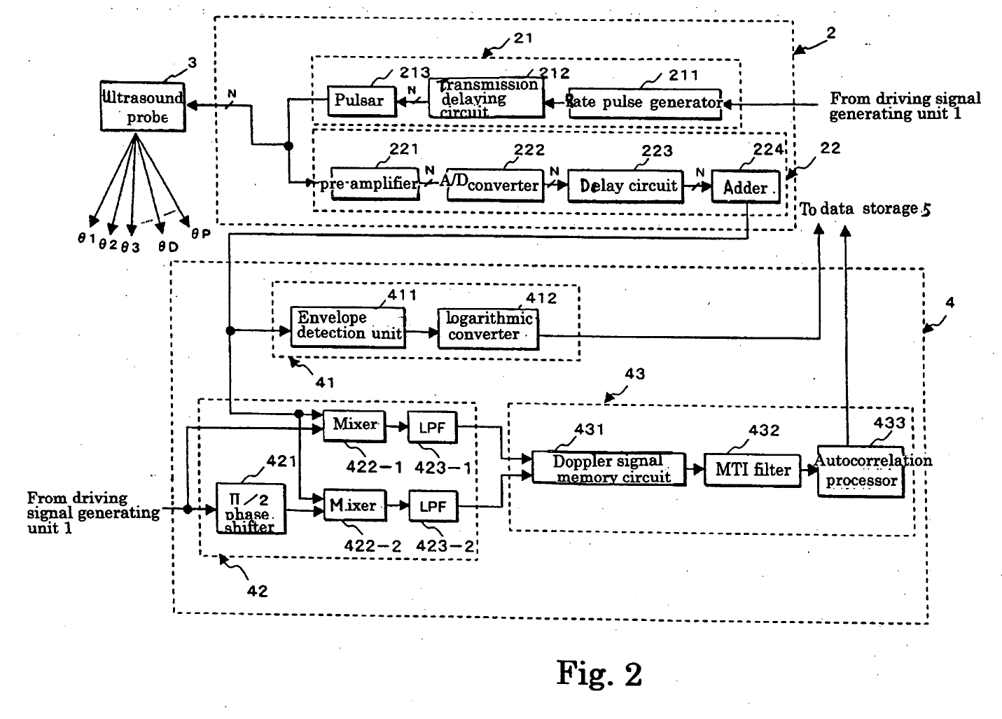

FIG. 2 is a block diagram for illustrating a transmitting and receiving unit and a data generating unit of the ultrasound diagnostic apparatus shown in FIG. 1. The ultrasound diagnostic apparatus 100 comprised of a drive signal generating unit 1, a transmitting unit 21 for transmitting ultrasound to a stressed object (patient's body, not shown) through a ultrasound probe 3, a receiving unit 22 for receiving ultrasound echo signals reflected or scattered from the object, and an image data generating unit 4 for generating images by processing the ultrasound signals from the receiving unit 22. The transmitting unit 21 and the receiving unit 22 are included in transmitting and receiving unit 2.

Data generating unit 4 is comprised of a B mode data generating unit 41, for generating B mode data based on receiving signals supplied from an adder 224 of the receiving unit 22, a Doppler signal detecting unit 42 for detecting Doppler signals by optionally detecting the receiving signals and a Doppler data generating unit 43 for generating blood flow Doppler data or tissue Doppler data based on the detected Doppler signals. Further, a system control unit 50 of the ultrasound diagnostic apparatus 100 includes a CPU 11 for controlling an entire operation of the apparatus and a storage unit 5 for storing ultrasound reception data collected in the image data generating unit 4 and index data added to the collected image data. The index data includes information, such as, the protocol at that time when the data is acquired. The ultrasound diagnostic apparatus 100, further includes a display unit 7 for displaying images on a monitor 73 by reconstructing and mapping the acquired data at positions that corresponded to the transmission and reception of ultrasound in order to perform a display layout.

Ultrasound transmitting and receiving surface of the ultrasound probe 3 is fixed on a body surface of a patient and ultrasound is transmitted and received along a first scanning direction θ1 (FIG. 2) by a control signal from CPU 11. A rate pulse generator 211 in the transmitting unit 21 generates a rate pulse for deciding a repeating period of ultrasound for radiating into the patient by dividing the drive signals supplied from the drive signal generating unit 1. The rate pulses are supplied to a transmission delaying circuit 212. The transmission delaying circuit 212 affords a focusing delay time for focusing ultrasound into a predetermined depth and a deflection delay time for transmitting ultrasound along a scanning direction θ1. The rate pulses are supplied to a pulsar 213. Pulsar 213 supplies driving signals that are generated by the rate pulses to ultrasound 3 through a cable (not shown) in order to radiate ultrasound pulses along a first scanning direction θ1. A portion of the radiated ultrasound pulses are reflected at a boundary surface between organs, each of which has a different acoustic impedance, or at tissues. When ultrasound reflects off of moving reflectors, such as cardiac walls or blood cells, ultrasound frequencies receive Doppler deviations.

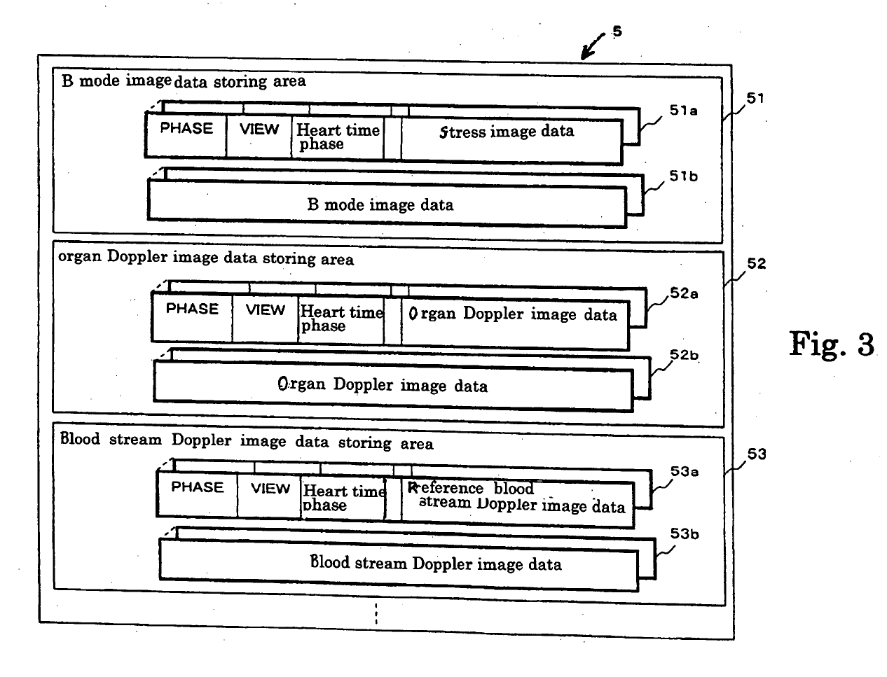

The ultrasound reflection waves (echoed ultrasound) are received at ultrasound probe and converted into reflection signals (receiving signals). The receiving signals are amplified at pre-amplifiers 221 of independent N channels in the receiving unit 22 to a predetermined amount. Then the amplified signals are converted to digital signals at A/D converter 222. The converted digital receiving signals are delayed at a predetermined time in the receiving delay circuits 223, and supplied to B mode data generating unit 41 in the data generating unit 4 after adding at an adder 224. In the receiving delay circuits 223, delay times for focusing the ultrasound reflection waves from a predetermined depth and for giving strong directivity to the reflection ultrasound waves are set by control signals from the system control unit 11. The output signals of adder 224 supplied to B mode data generating unit 41 are stored in a first B mode image data storing area 51a (a first storage area, FIG. 3) after performing envelope detection and logarithmic conversion.

The input unit 8 operates various input operations, such as input of patient data, selection of an image collecting mode, setting conditions for transmission or reception and input of various commands. A patient body measuring unit 9 detects ECG (electrocardiogram) signal of the patient or collects PCG waves. A heart time phase measuring unit 10 measures a cardiac time phase of the detected ECG signals, based on, for example, R waves. To collect list data among the index data that are added to data stored in the data storage unit 5 or an outside memory, a list data collecting unit 6 may be provided.

The ultrasound probe 3 includes a plurality (N) of minute ultrasound transducers for transmitting and receiving ultrasound by being placed in contact with a patient body surface. At a transmitting time, the ultrasound transducers convert electric pulses to ultrasound and the radiation direction is adjusted by the delay circuits 212. At a receiving time, the ultrasound transducers convert ultrasound reflection waves to receiving signals. The ultrasound probe 3 is coupled to the transmitting unit 21 and the receiving unit 22 through ECG cables. The possible types of ultrasound probe 3 include a sector scanning type, a linear scanning type, and a convex scanning type. In this embodiment, a sector scanning type ultrasound probe 3 is used to measure cardiac functions.

As shown in FIG. 2, the transmitting unit 21 for generating drive signals for radiating ultrasound through the ultrasound probe 3 includes a rate pulse generator 211, a transmission delay circuit 212 and a pulsar 213. Rate pulse generator 211 generates rate pulses for deciding a repeating cycle of ultrasound transmission by dividing continuous waves or rectangular waves supplied from the driving signal generating unit 1. The rate pulses are supplied to transmission delay circuit 212. The transmission delay circuit 212 is constructed by a plurality of independent delay circuits that are the same number (N) of the transmitting ultrasound transducers (N channels). At a transmission time, each delay circuit provides a delay time in order to obtain a fine width of beam for focusing the transmitting ultrasound into a prescribed depth and also to provide a delay time to rate pulses in order to radiate the transmitting ultrasound to predetermined directions (θ1-θP, FIG. 2). The rate pulse is supplied to a pulsar 213. Pulsar 213 includes driving circuits of independent N channels and generates driving pulses for driving ultrasound transducers installed in ultrasound probe 3 based on the rate pulse.

Receiving unit 22 performs a phase adjusted adding operation to the receiving signals from the ultrasound probe 3. Receiving unit 22 includes a pre-amplifier 221 having N channels, an A/D converter 222, a receiving delay circuit 223 and an adder 224. Pre-amplifier 221 keeps a sufficient S/N (signal to noise ratio) by amplifying feeble signals that are converted into electric receiving signals through ultrasound transducers. Receiving signals of N channels being amplified up to a prescribed volume in the pre-amplifier 221 are converted to digital signals at A/D converter 222. The converted digital signals are supplied to reception delay circuit 223. Receiving delay circuit 223 provides focusing delay times for focusing ultrasound reflection waves from a predetermined depth and provides a deflecting delay time to each receiving signals of N channels outputted from A/D converter 222 for setting each receiving direction against a prescribed direction. Adder 224 adds the receiving signals from the receiving delay circuit 223. Through the receiving delay circuit 223 and the adder 224, receiving signals obtained from a prescribed direction are added to receiving signals with phase adjustment.

The B mode data generating unit 41 includes an envelope detection unit 411 and a logarithmic converter 412. Envelope detection unit 411 detects an envelope of the receiving signals that are provided from the adder 224 in the receiving unit 22 after the adjusting of phases. The detected envelope signals are converted in the logarithmic converter 412. Generally, reception signals from an object have an amplitude of a wide dynamic range over 80 dB. To display such reception signals of wide dynamic range into a normal television monitor having dynamic range of around 30 dB, there needs to be performed an amplitude compression through logarithmic conversion. This is also possible by switching an order of the envelope detecting unit 411 and the logarithmic converter 412.

Doppler signal detection unit 42 includes a π/2 phase shifter 421, mixers 422-1 and 422-2, low pass filters (LPFs) 423-1 and 423-2 used to detect Doppler signals by performing orthogonal phase detection against reception signals provided from adder 224 in the receiving unit 22. Thus, input signals of Doppler signal detection unit 42 provided from receiving unit 22 are supplied to each first input terminal of mixers 422-1 and 422-2. Rectangular waves of drive signal generating unit 1 are directly supplied to second input terminals of mixer 422-1. The rectangular waves have almost the same frequency as the center frequency of this input signal. Further, the rectangular waves are supplied to a second input terminal of the mixer 422-2 by shifting its phase by 90 degrees in a π/2 phase shifter 421. Each output of Mixers 422-1 and 422-2 are respectively supplied to LPFs 423-1 and 423-2 in order to detect a difference component only between output signal frequency of the receiving unit 22 and output signal frequency of the reference signal generating unit 1.

Thus, Doppler signal detection unit 42 performs an orthogonal phase detection against receiving signals that are obtained through a plurality of transmission/reception in a predetermined scanning direction and supplies an obtained I component (a real component of complex signal) and a Q component (an imaginary component of the complex signal) to the Doppler data generating unit 43. Doppler data generating unit 43 includes a Doppler signal memory circuit 431, a MTI (Motion Targeted Indicator) filter 432, and an autocorrelation processor 433. Doppler signals outputted from Doppler signal detection unit 42 are once stored in the Doppler signal memory circuit 431. A digital MTI filter 432 reads Doppler signals stored in Doppler signal memory circuit 431 and extracts components relating to blood stream data in the Doppler signals or components relating to movement data of cardiac walls. Autocorrelation processor 433 calculates an autocorrelation value of the extracted Doppler components in MTI filter 432. Further, based on the autocorrelation values, the autocorrelation processor 433 generates blood stream Doppler data indicating blood streams and organ Doppler data indicating movement speeds of cardiac walls in each unit of scanning directions.

To extract the blood stream Doppler component, a high pass filter characteristic or a band pass filter characteristic is set in MTI filter 432 for excluding organ Doppler components that are distributed in a low frequency area. Although an MTI filter being set with a low pass filter characteristic is applicable to extract an organ Doppler component in order to exclude a blood stream Doppler component, it is not necessary when the blood stream Doppler component is extremely small when compared to an organ Doppler component.

Data storage unit 5 shown in FIG. 1 stores B mode image data, blood stream Doppler data, and organ Doppler data that are generated in data generating unit 4 in accordance with the scanning directions (θ1-θP). Further, data storage unit 5 is used to generate reference organ Doppler image data for indicating motion speed data, such as cardiac walls and reference blood stream Doppler image data for indicating blood stream speed data in a cardiac ventricle, by storing blood stream Doppler data and organ Doppler data.

The data collecting protocol that is supplied from the CPU 11 to data storage unit 5 adds a protocol data supplied from system control unit 11 and heart time phase data supplied from the heart time phase measuring unit 10 to the image data as index data. Further, the CPU 11 generates thumbnail image data for each index data by using the image data stored in the data storage unit 5. The generated thumbnail image data are stored in a thumb nail image data storing area in the data storage unit 5.

FIG. 3 is a model illustration of various types of image data stored in the data storage unit 5 in the system control unit 50. Stress images generated in the B mode image data generating unit 41 are stored in the B mode image data storing area in the data storage unit 5, and organ Doppler image and blood stream Doppler image generated in the Doppler data generating unit 43 are respectively stored in the organ Doppler image data storing area 52 and blood stream Doppler image data storing area 53. In the B mode image data storing area, there is a stress data storage area 51a for storing stress image data with adding protocol data of “phase” and “view,” heart time phase data, and a normal storing area for storing image data acquired by a normal mode of the ultrasound apparatus. Similarly, in the organ Doppler image data storing area 52 and blood stream Doppler image data storing area 53, each of reference organ Doppler image data and reference blood stream Doppler image data are stored with data regarding stress echo protocol at that time when the reference organ Doppler image data and the reference blood stream Doppler image data are acquired, respectively.

List data collecting unit 6 generates an image data list of the data stored in the data storage unit 5. Thus, the list data collecting unit 6 collects each of the stress image data 51a, thumbnail image data for the respective reference organ Doppler image data 52a, and reference blood stream Doppler image data 53a that are stored in the thumbnail image data storing area in the data storage unit 5 and B mode image data 51b, and the respective thumbnail image data for organ Doppler image data 52b and blood stream Doppler image data 53b that are acquired by a normal mode of the ultrasound diagnostic apparatus. Further, it collects list data for generating a reference image data list based on the affixed protocol data (index data) that are added to the reference image data, such as reference organ Doppler image data 52a or blood stream Doppler image data 53a.

Display unit 7, as shown in FIG. 1, includes a display data generating circuit 71, a conversion circuit 72, and a monitor 73. Stress image data and reference image data being generated by data generating unit 4 are converted by scanning into a prescribed format in the display data generating circuit 71. Further, the image data are D/A converted in conversion circuit 72, which converts the image data so as to display the image data in television form on a monitor 73. The display data generating circuit 71 reads in an order stress image data of a plurality of different “phases” at prescribed “views” that are stored in B mode data storing area 51a of the data storage unit 5, based on heart time phase data, and displays them in a predetermined display format. The conversion circuit 72 generates video signals by performing D/A conversion and TV format conversion for the composed data in order to display them on the monitor 73. By repeating these processes for the respective heart time phases, each of the stress image data at a plurality of “phases” are displayed so as to compare the motion images.

Display data generating circuit 71 constructs an image data list or a reference image data list based on list data being supplied from the list data collecting unit 6 and displays them in accordance with a preliminarily determined display format. In this embodiment, it is preferable to form the image data list by arranging thumb nail images stored in the data storage unit 5 based on various image data generated through a stress echography or a normal ultrasound diagnosis.

The input unit 8 is an interactive interface that includes input devices, such as a display panel on an operation panel, keyboard, truck ball, mouse, or selection button. The input unit 8 sets and selects various conditions for generating and displaying stress image data and reference image data, and further operates inputting of command signals. Practically, in the generation of stress image data, patient data is inputted, an image collecting mode is selected, stress echo protocol is set or renewed, and also commands for suspending or interrupting generation of the stress image data are inputted. To display a comparing display for the stress image data, reference image data is selected. Further, commands for requesting image data list and reference image data list and for instructing an end of a display of the reference image data are inputted though the input unit 8.

Various set conditions and selected data in the input unit 8 are stored in the storage unit 5 by processing in the control unit 11. In the storage unit 5, preliminarily determined stress echo protocols are also stored. The system control unit 50 controls generation, storage, and display of stress image data and reference image data based on the above-explained input data and preliminarily determined stress echo protocol by totally controlling each of the units in the ultrasound diagnostic apparatus 100.

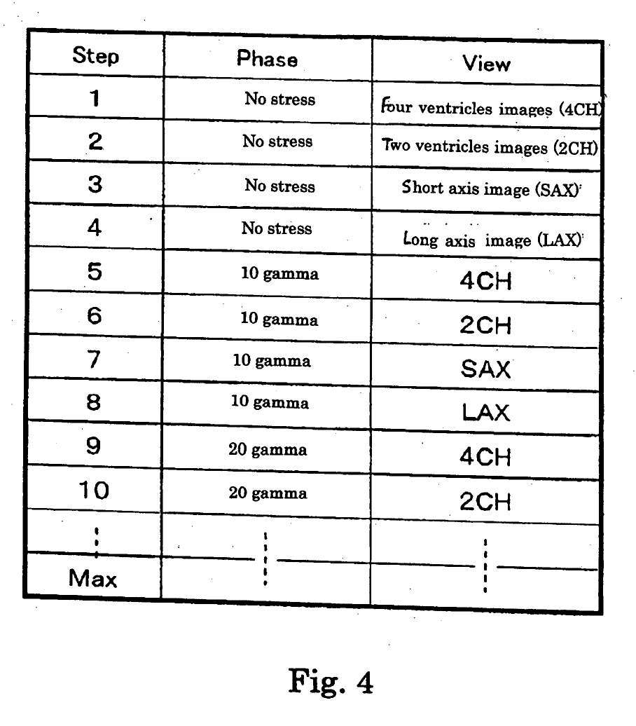

FIG. 4 depicts a practical example of stress echo protocols stored in the storage unit 50. By these stress echo protocols, a patient's heart is firstly displayed in right and left atriums and right and left chambers as “four ventricle images (4CH)” under a “no stress” state of the “phase”. Next, at the same “no stress” state, either one of right or left atriums and either one of right or left chambers are displayed as “two ventricles images (2CH)” In turn, at the same “no stress” state of the “phase”, a tomography image along a short axis direction is displayed as a “short axis image (SAX)” and then a tomography image along a long axis direction is displayed as a “long axis image (LAX)”. Similarly, each stress image data of “four ventricle images”, “two ventricle images”, “short axis image” and “long axis image” at the respective stages of “10 gamma”, “20 gamma”, “40 gamma” of the “phase” are in turn generated.

The body measuring unit 9 collects ECG signals from a patient. The heart time phase measuring unit 10 measures heart time phases based on, for example, R wave of ECG signals supplied from the body measuring unit 9. In this embodiment, the body measuring unit 9 includes ECG measuring unit for collecting ECG signals. Of course, it is possible to include a PCG measuring unit for collecting phone cardio grams of the patient.

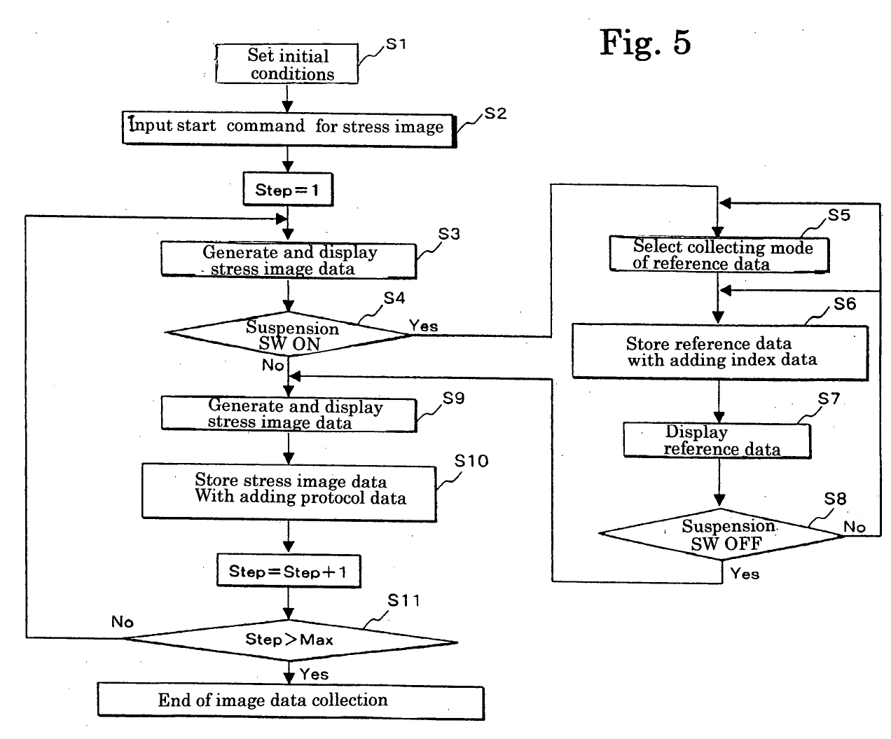

With reference to FIG. 5, processes for generating stress image data and reference image data consistent with this embodiment will be explained. FIG. 5 is a flowchart for explaining a process for generating the image data according to this embodiment. Prior to the generation of stress image data, an operator inputs patient data through the input unit 8 and selects an image collecting mode of the stress image data, as an initial set (step S1). Further, as the initial set, electrodes of the ECG measuring unit are fixed on an patient and ECG signals detected through the electrodes are supplied to heart time phase measuring unit, and the heart time phases are supplied to the system control unit 50.

After setting the initial conditions, a start command for starting generation of stress image data is inputted through the input unit 8 (step S2). By supplying the first stress image generation command signal to system control unit 50, at a first “Step=1”, stress images of the “four ventricles images” under the “no stress” of the “phase” are generated and displayed. To do this, the CPU 11 controls the transmission and reception ultrasound along the scanning directions θ1-θP and stores each of the acquired data into B mode image data storing area 51a. The B mode data along the respective scanning directions of θ1-θP are successively stored in the B mode image data storing area 51a and form stress image data for one flame.

Image signals reconstructed through the display data generating circuit 71 and the conversion circuit 72 are displayed on the monitor 73. Similarly, ultrasound transmissions and receptions along the respective scanning directions θ1 to θP are repeated and the acquired stress image data are displayed on the display 7 in a real time (step S3. An operator renews a position and direction of the ultrasound probe 3 while observing stress images displayed on the monitor 73 of the display 7 and fixes the probe at the most appropriate position for acquiring the “four ventricle images”.

After observing the stress image of “four ventricle images” displayed on the monitor 73, if reference images, for example, organ Doppler images, are desired to be displayed, a suspension switch provided on an operating panel of the input unit 8 is turned ON (step S4). By turning the suspension switch ON, a command for suspending the generation of stress image data is inputted and a reference image collecting mode for reference organ Doppler image data is selected (step S5).

The CPU 11 receives a stress image generation suspending command and selection signal from the input unit 8. The CPU 11 drives the transmitting and receiving unit 2 so as to repeat a predetermined number of times (L) of ultrasound transmission and acquired receiving signals are supplied to the Doppler signal detection unit 42. The received signals are detected as a Doppler signal (a complex signal) of two channels through orthogonal phase detection at mixers 422-1, 422-2 and low pass filters (LPFs) 423-1, 423-2 in Doppler signal detection unit 42. Each of a real component and an imaginary component of the Doppler signal is stored once in a Doppler signal memory circuit 431 of Doppler data generating unit 43.

After storing the Doppler signals along the scanning direction θ1, the CPU 11 successively reads L numbers of Doppler signal components that correspond to a prescribed depth among Doppler signals that are stored in Doppler signal storing circuit 431. The read Doppler signal components are supplied to digital MTI filter 432. The MTI filter 432 extracts organ Doppler components by performing a filtering process on the supplied Doppler signal components. The extracted organ Doppler component is supplied to autocorrelation processor 433. After performing autocorrelation process of the Doppler signals supplied from MTI filter 432, the autocorrelation processor 433 calculates movement speeds of cardiac muscles based on a result of the autocorrelation process. By performing these calculations for other depths at the scanning direction θ1, the calculation of movement speeds (organ Doppler data) of cardiac muscles at a scanning direction θ1 are stored in organ Doppler image data storing area 52a (FIG. 3) of data storage unit 5. Similarly, CPU 11 transmits and receives ultrasound along scanning directions θ2 to θP, and organ Doppler data that are obtained along each of the scanning directions are respectively stored in organ Doppler image data storing area 52 of data storage unit 5. Thus, organ Doppler image data storing area 52a successively stores organ Doppler data stores along each of the scanning directions θ1 to θP, so as to generate reference organ Doppler image data for one flame of a screen.

The CPU 11 adds protocol data that are stored in the data storage unit 5 and heart time phase data supplied from the heart time phase measuring unit 10 to the reference organ Doppler image data being stored in organ Doppler image data storing area 52a as an index data. In this case, protocol data for “four ventricle images” at “no stress” are stored in organ Doppler image data storing area 52 with reference organ Doppler image data and heart time phase data (step S6).

Display data generating circuit 71 converts reference organ Doppler image data for one flame of a screen that is stored in data storage unit 5 in a prescribed display format and displays the Doppler image data for one frame through use of the conversion circuit 72. Similarly, ultrasound transmission and reception along each of scanning directions θ1 to θP are repeated. And the obtained reference organ Doppler image data are displayed on display unit 7 at a real time (step S7).

After observing reference organ Doppler image data displayed on the monitor 73, if reference image data under another image display mode, for instance, reference blood stream Doppler image data is desired to be generated, the operator does not turn OFF the “suspension” switch (step S8, No), and selects an image collecting mode for reference blood stream Doppler image data through input unit 8 (step S5). By the similar process for the reference organ Doppler image data, the reference blood stream Doppler image data are successively generated and stored in the blood stream Doppler image storing area 53a with the addition of the protocol data and the heart time phase data (step S6). The reference blood stream Doppler image data are displayed on monitor 73 (step S7). To generate blood stream Doppler image data, MTI filter 432 is set in a high pass characteristic for extracting blood stream Doppler component by excluding the organ Doppler component.

After generating the reference organ Doppler image data, if it does not need to generate reference image data under another reference image displaying mode, an operator turns the “suspension” switch OFF (step S8, Yes). By turning the suspension switch OFF, a restart command is supplied to the CPU 11 and it instructs restart of the generation of stress image data for “four ventricle images” at “no stress” by controlling the transmitting and receiving unit 2, data generating unit 4, data storing unit 5, and display unit 7 (step S9). By inputting a storing instruction command signal through input unit 8, stress image data obtained during several cardiac cycles are stored in B mode image data storing area 51a with protocol data and heart time phase data (step S10).

Similar processes are repeated for each of the following steps, (Step=2 to Step=Max) based on stress echo protocol shown in FIG. 4 and stress image data are generated (steps S3 to S11). The obtained stress image data and reference image data are stored in the storing areas in the data storage unit 5 with the addition of the corresponding protocol data and heart time phase data. When the step of stress echo protocol exceeds “MAX” (step S11, Yes), the collection of the stress image data and the reference image data is finished.

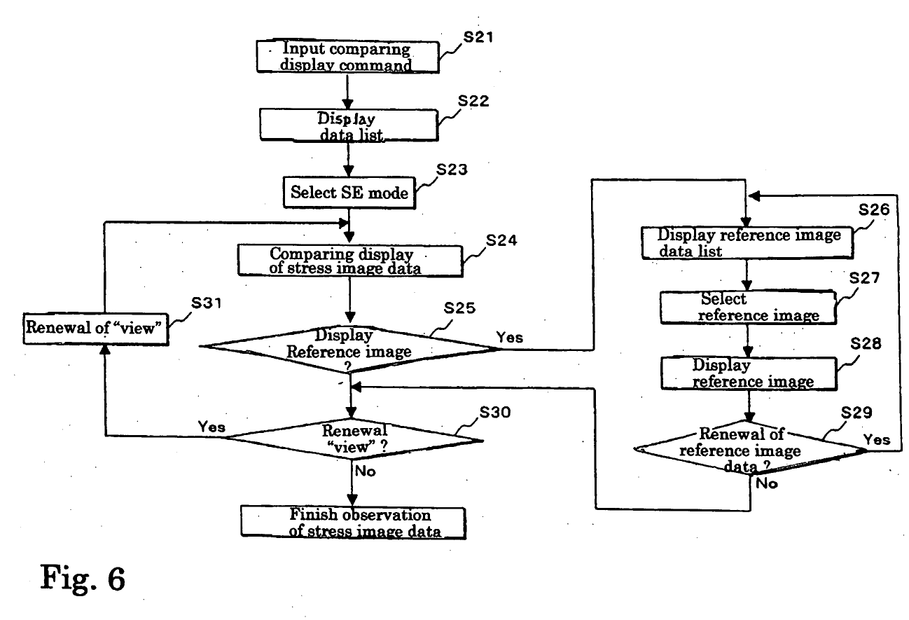

FIG. 6 is a flowchart for explaining a process for performing comparison display of stress image data. When a comparison displaying command is inputted through the input unit 8 (step S21), the list data collecting unit 6 receives the comparison displaying command through CPU 11. Based on the command, the list data collecting unit 6 reads necessary list data among the data stored in the data storage unit 5 and supplies them to the displaying data generation circuit 71. The displaying data generation circuit 71 constructs a data list based on the supplied list data and the constructed data list is displayed on the monitor 73 (step S22). It is also possible to preliminary generate each thumb nail image data for the various data stored in the data storage 5, and the display data generation circuit 71 constructs an image data list by using thumbnail images that are supplied from the data storage unit 5 through the list data collecting unit 6.

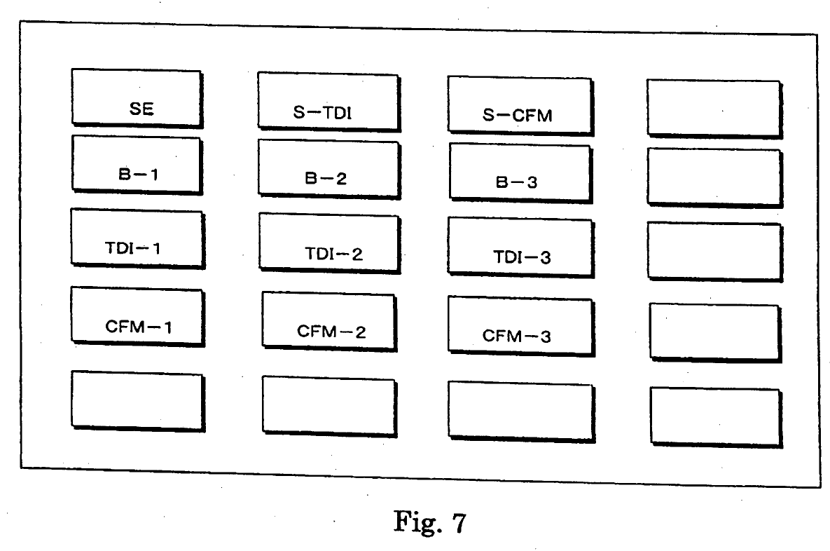

FIG. 7 explains a practical embodiment of the image data list that is displayed on the monitor 73 in the displaying unit 7. Various thumbnail images, such as a thumb nail image “SE (Stress Echo)” for the stress image data being generated based on stress echo protocol, and a thumb nail image “S-TDI (Stress-Tissue Doppler Imaging)” for reference organ Doppler image data, and a thumb nail image “S-CFM (Stress Flow Color Mapping)” for reference blood stream Doppler image data that are generated as reference image data, and are arranged on the monitor. Further, thumbnail images for various data that are acquired in a normal mode of the ultrasound diagnostic apparatus are arranged as thumb nail images “B-1”, “B-2”, “B-3”—for B mode image data, thumb nail images “TDI-1”, “TDI-2”, “TDI-3”—for organ Doppler image data and thumb nail images “CFM-1”, “CFM-2”, “CFM-3”—for blood stream Doppler image data.

Among the image data list displayed on the monitor 73, an operator selects the thumb nail image “SE” by using an input device of the input unit 8 (step S23). By doing so, stress image data that are stored in the B mode image data storing area 51a are displayed based on a predetermined displaying order (step S24). For example, the displaying data generation circuit 71 in the display unit 7 reads four kinds of stress image data of “no stress”, “10 gamma”, “20 gamma” and “40 gamma” as “four ventricle images” based on each protocol data added to the respective image data and displays as motion images with synchronizing to heart time phase data added to the respective image data.

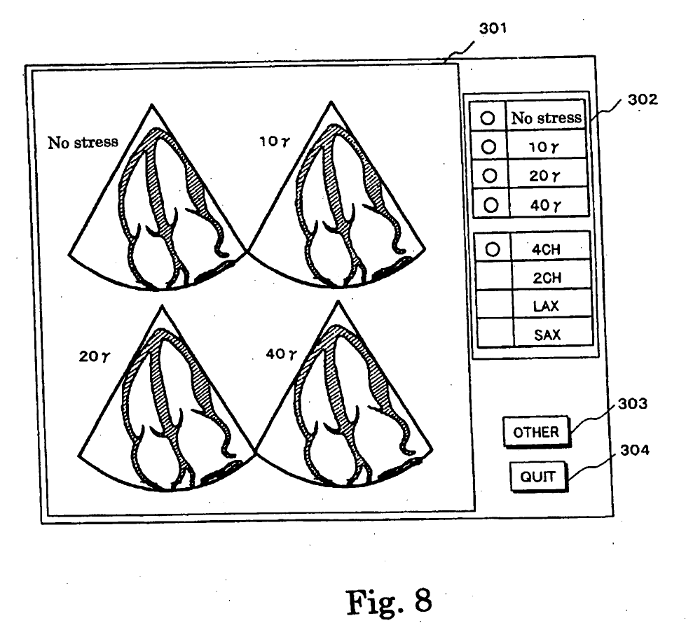

FIG. 8 illustrates an example of a displayed screen of stress image data on a monitor 73 of displaying unit 7. The displayed screen in an image data displaying mode includes an image data display area 301 for displaying stress image data, a protocol data displaying area 302 for displaying data of “phase” and “view” for the displayed stress image data, a reference image requesting “OTHER” button 303 for requesting reference image data during displaying of the stress image data and a “QUIT” button for ending a display of the reference image data. In the image data displaying area 301, stress image data of “four ventricle images” at each of “phases” of “no stress”, “10 gamma”, “20 gamma” and “40 gamma” are displayed synchronized to heart beats.

Normally, displaying data generation circuit 71 in the display unit 7 selects stress image data for one heart beat cycle among a several heart beat cycles at each of the “phases”. Further, the displaying data generation circuit 71 generates displaying data at a prescribed heart beat time phase by composing image data at each of the “phases” based on heart beat time phase data affixed to these stress image data. Thus, in the monitor 73 of displaying unit 7, stress image data at each of the “phases” for one heart beat cycle is repeated (i.e., looped display).

If reference image data is needed to be displayed during displaying of stress image data at the above-mentioned “view” (step S25, Yes), an operator selects a reference image requesting “OTHER” button 303 (FIG. 8) that is displayed on the monitor 73 through the input device of input unit 8 by clicking on button 303. By selecting this, a list of the reference image data stored in the data storage unit 5 is displayed on the monitor 73.

When the list data collecting unit 6 receives a reference image requesting signal through the CPU 11 from the input unit 8, it reads necessary list data for constructing reference image data list among the index data for the reference image data, (i.e., reference organ Doppler image data and reference blood stream Doppler image data that are stored in the data storage unit 5). The read list data are supplied to the display data generation circuit 71 in the display unit 7. The display data generation circuit 71 constructs and displays a reference image data list of a prescribed format on the monitor 73 based on the supplied list data (step S26).

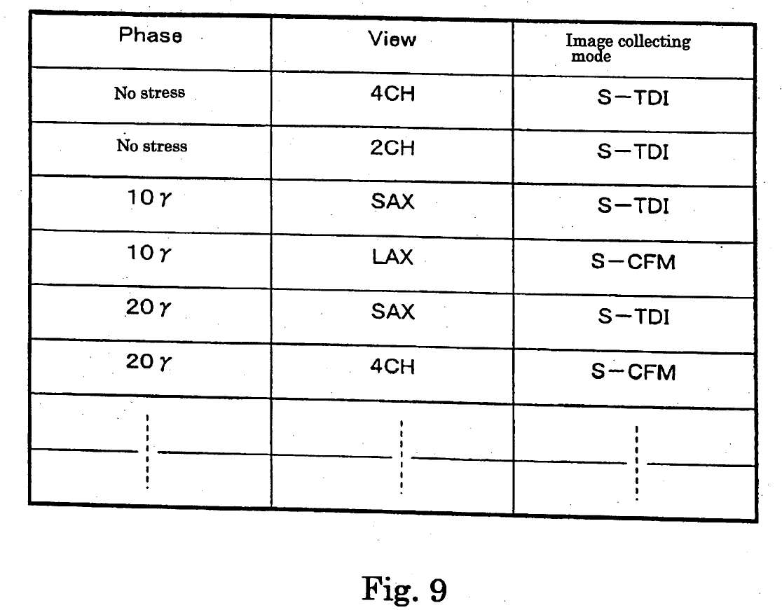

FIG. 9 illustrates an example of the reference image data list displayed on the monitor 73. In accordance with a collection order, “four ventricle images” and “two ventricle images” at a phase “no stress”, or, reference organ Doppler image “S-TDI” generated as a “short axis image” at “10 gamma”, or reference blood stream Doppler image “S-CFM” collected at a “long axis image” of “10 gamma” and so on are successively displayed.

When an operator selects a desired reference image data among the list of reference image data displayed on the monitor 73 by using an input device of input unit 8, the monitor 73 changes again to the image data displaying mode, and the selected reference image data are displayed on the image data displaying area 301 (steps S27 and S28). If another reference image data are required to be displayed (step S29, Yes), a newly selected reference image data is displayed on the monitor 73 by using reference image data list that is displayed again by selecting the reference image requesting “OTHER” button 303 (steps S26-S29).

When the display of reference image data finishes (step S29, No), the displayed screen goes back to the displaying mode of stress image data by selecting the “QUIT” button 304 that is displayed on the displayed screen of the image data displaying mode. By doing so, when a comparison of stress image data for “four ventricle images” have has, it can be followed by a comparison of stress image data or reference image data for “two ventricle images” by inputting a “view” renewal signal through the input unit 8 (step S31). Further, comparisons of stress image data or reference image data of a “short axis image” and a “long axis image” can also be performed.

According to the embodiment of the apparatus and method consistent with the present invention, it becomes possible to easily search a desired stress image data or reference image data among various image data stored in the storage unit by storing both generated image data and reference image data with adding index data relating protocol data at a generation time of the reference image data. Accordingly, it can easily display desired image data in a predetermined display format for performing a comparison display. Consequently, it becomes possible to perform an efficient diagnosis by reducing operator difficulty in searching for appropriate image data for comparison.

Further, according to the embodiment of the apparatus and method consistent with the present invention, to read stress image data for a comparison display in a predetermined display format, it becomes possible to easily read desired stress image data and desired reference image data among various image data stored in the same storage unit by storing the generated image data together with the protocol data during generation of stress image data and reference image data. Further, since it becomes possible to construct a list of stress image data and generated reference image data, it becomes possible for an operator to easily select a desired reference image data based on the displayed reference image data list. Consequently, efficiency of diagnosis can largely improved with avoiding load to the operator.

In the above-described embodiments, B mode image data is explained as the stress image data. Of course, it is possible to use other image data that is generated in another image collecting mode, such as organ Doppler image data or blood stream Doppler image data, as the stress image data.

In the above-explained embodiments, protocol data is added to the image data (so-called raw data) that is generated by storing output data from the data generating unit in an order prior to the scanning conversion. Of course, it is possible to add protocol data to displaying image data that are scanning converted in the display data generating circuit of the display unit. In this case, various reference data of “kinds of data” such as, for example “displaying image data”, “raw data”, “a time series data” and “measured value” are displayed in the reference image data list generated in displaying data generating unit other than “phase”, “view”, “image collecting mode” as shown in FIG. 9. For example, it is preferable to construct the reference image data list in a large classification of “displaying image data”, “a time series data” and “measured value”, and classify in a middle level by using “phase”, “view” and “image collecting mode”.

In the above-explained embodiments, the image data list and the reference image data list are displayed on a monitor in displaying unit. Of course, it is possible to display this on a display panel of input unit. Further, in a case where a plurality groups of image data are stored based on a plurality of different stress echo protocols in the same memory circuit, it is desirable to add its identification mark to stress image data and to reference image data protocol together with heart beat time phase data. Of course, the protocol data “phase” and “view” in the present invention are not limited to the above-explained embodiments.

Other embodiments consistent with the present invention will be apparent to those skilled in the art from consideration of the specification and practice of the present invention disclosed herein. It is intended that the specification and examples be considered as exemplary only, with a true scope and spirit of the present invention being indicated by the following claims.

What is claimed is:

1. An ultrasound diagnostic apparatus for transmitting and receiving ultrasound to and from an object being given a stress, the apparatus having a special mode for collecting received data from the stressed object based on a prescribed collecting protocol, the ultrasound diagnostic apparatus comprising:
a control unit configured to control the transmission and reception of ultrasound and to control a collecting and displaying sequence for a plurality of stress image data that are acquired based on a plurality of different conditions of the stress;
a first storage area configured to store the plurality of stress image data collected based on the prescribed collecting protocol at a first predetermined position;
an input unit configured to input an interrupt command for suspending the collecting and displaying sequence based on the prescribed collecting protocol and to input a return command for restarting the suspended sequence;
a reference data generating unit configured to collect reference data based on another data collecting mode that is different from the prescribed collecting protocol by using the received data collected during the suspension of the collecting and displaying sequence;
a second storage area configured to store the reference data with added index data regarding the prescribed collecting protocol at a second predetermined position under control of the control unit; and
a display unit configured to display a reconstructed stress image and corresponding reference data under the control of the control unit, the corresponding reference data is displayed by using the index data added to the reference data.

2. The ultrasound diagnostic apparatus according to claim 1,
wherein the index data includes at least one of data indicating an obtained stress echo inspection, data indicating acquisition during the suspension, and data of phase and view comprising the prescribed colleting protocol just before the sequence based on the prescribed collecting protocol is suspended.

3. The ultrasound diagnostic apparatus according to claim 1, wherein the display unit is configured to collectively display the plurality of stress image data acquired based on the prescribed collecting protocol with one icon, and to display each of the reference data acquired during the suspension by a respective icon or a respective thumbnail.

4. The ultrasound diagnostic apparatus according to claim 1, further comprising:
a third data storage area; and
the display unit includes a reference data list displaying portion and a reference data selecting portion, wherein
the reference data list displaying portion displays the reference data as a list based on the index data added to the reference data that are stored in the second storage area, and
the reference data selecting portion selects the reference data on the displayed list.

5. The ultrasound diagnostic apparatus according to claim 1,
wherein the index data includes heart time phase data from the stressed object, and
the display unit is configured to display the stress image data synchronized to the heart time phase data.

6. The ultrasound diagnostic apparatus according to claim 1, wherein the display unit is configured to display the reference data as a list, and
the input unit is configured to select a desired reference data.

7. The ultrasound diagnostic apparatus according to claim 6,
wherein the reference data list displayed on the display unit includes respective classifications for each item of the phase, the view, the prescribed collecting protocol, and a kind of data.

8. An ultrasound data generating apparatus for transmitting and receiving ultrasound to and from an object being given a stress, the ultrasound data generating apparatus comprising:
a control unit configured to control generation of a plurality of ultrasound data that are acquired under a plurality of different conditions of the stress based on a prescribed protocol; and
a data storage unit configured to store ultrasonic data collected between a suspension and a return of the prescribed protocol so as to correspond with data regarding the prescribed protocol at a time of the suspension.

9. The ultrasound data generating apparatus according to claim 8,
wherein the prescribed protocol is to collect a plurality of ultrasound data by varying an amount of the stress given to the object or to change an imaging portion of the object.

10. The ultrasound data generating apparatus according to claim 8, further comprising:
a display unit configured to display the ultrasound data,
wherein the control unit is configured to control a display of the plurality of data that are acquired based on the prescribed protocol in a predetermined format and a plurality of ultrasound data that are acquired during a suspension of the protocol so as to correspond to the prescribed protocol.

11. The ultrasound data generating apparatus according to claim 8, further comprising:
a selecting unit configured to select each of the plurality of ultrasound data that are acquired during the suspension of the protocol; and
a display control unit configured to control a display of data regarding the protocol that is stored in correspondence with the selected ultrasound data.

12. An ultrasound diagnostic method having a stress image collecting mode based on received data from an object being given a stress, the ultrasound diagnostic method comprising:
controlling a sequence of collecting and displaying a plurality of the stress image data acquired based on a prescribed collecting protocol and varying conditions of the stress;
storing the collected plurality of stress image data in a first storage area;
inputting an interrupt command for suspending the sequence of collecting and displaying the plurality of the stress image data based on the prescribed collecting protocol and a return command for restarting the suspended sequence;
collecting reference data based on another data collecting mode that is different from the prescribed collecting protocol by using data received during the suspension of the sequence;
adding index data regarding the prescribed collecting protocol to the reference data;
storing the reference data with added index data regarding the prescribed collecting protocol at a second storage area; and
displaying a reconstructed stress image and corresponding reference data, the corresponding reference data is displayed by using the index data added to the reference data.

13. The ultrasound diagnostic method according to claim 12,
wherein the index data includes at least one of data indicating an obtained stress echo inspection, data indicating acquisition during the suspension, and data of phase and view comprising the prescribed colleting protocol just before the sequence based on the prescribed collecting protocol is suspended.

14. The ultrasound diagnostic method according to claim 12, further comprising:
collectively displaying the plurality of stress image data acquired based on the prescribed collecting protocol with one icon; and
displaying each of the reference data acquired during the suspension by a respective icon or a respective thumbnail.

15. The ultrasound diagnostic method according to claim 12, further comprising:
storing a reference data list into a third data storage area;
displaying the reference data as a list based on the index data added to the reference data that are stored in the second storage area; and
selecting the respective reference data upon the displayed list.

16. The ultrasound diagnostic method according to claim 12, wherein the index data includes heart time phase data acquired from the stressed object into the index data, further comprising:
displaying the stress image data synchronized to the heart time phase data.

17. The ultrasound diagnostic method according to claim 12, further comprising:
displaying the reference data as a list; and
selecting a desired reference data through an input unit.

18. The ultrasound diagnostic method according to claim 17, wherein the reference data list includes respective classifications for each item of the phase, the view, the prescribed collecting protocol, and a kind of data.

19. An ultrasound data generating apparatus for generating ultrasound images of an object by transmitting and receiving ultrasound to and from a stressed object, the data generating apparatus comprising:
a stress image generating unit configured to generate a plurality of different stress images based on a prescribed protocol;
a reference data generating unit configured to generate a plurality of reference data in a different mode from the prescribed protocol;
a display unit configured to display the stress image and the reference data;
a controller configured to control the stress image generating unit, the reference data generating unit, and the display unit;
an operating unit configured to suspend and to return the prescribed protocol; and
a data storage unit configured to store ultrasound images that are collected during a period between the suspension of the prescribed protocol and the restart of the prescribed protocol in correspondence with data regarding the prescribed protocol at a suspended time.

20. The ultrasound data generating apparatus according to claim 19,
wherein the display unit includes a reference data list displaying portion and a reference data selecting portion,
the reference data list displaying portion is configured to display a list of the reference data based on the data regarding to the protocol that is added to the reference data; and
the display unit is configured to display reference data that is selected on the displayed list of the reference data.

21. The ultrasound data generating apparatus according to claim 19,
wherein the reference data generating unit is configured to generate anyone of image data, raw data, and measured data that are generated under an image collecting mode that is different from the stress image collecting mode.

22. The ultrasound data generating apparatus according to claim 19,
wherein the stress image generating unit generates B mode image data based on the received ultrasound, and
the reference data generating unit is configured to display either one of tissue Doppler image or blood flow Doppler image data.

23. An ultrasound data generating method for generating ultrasound images of an object by transmitting and receiving ultrasound to and from a stressed object, the ultrasound data generating method comprising:
generating a plurality of different stress images based on a prescribed protocol;
generating a plurality of reference data in a different mode from the prescribed protocol;
displaying the stress image and the reference data;
controlling the stress image generation, the reference data generation, and the display;
suspending and returning the prescribed protocol; and
storing ultrasound images that are collected during a period between the suspensions of the prescribed protocol and restart the prescribed protocol in correspondence with data regarding the prescribed protocol at a suspended time.

24. The ultrasound data generating method according to claim 23, further comprising:
displaying a list of the reference data,
wherein the list of the reference data is comprised of a list of the reference data based on the data relating to the prescribed protocol, which is added to the reference data, and
selecting the reference data on the displayed list of the reference data.

25. The ultrasound data generating method according to claim 23, further comprising:
generating as the reference data, anyone of image data, raw data, and measured data that are generated under an image collecting mode that is different from the stress image collecting mode.

26. The ultrasound data generating method according to claim 23, further comprising:
selecting a plurality of ultrasound images acquired during the suspension of the prescribed protocol; and
displaying data regarding the prescribed protocol that is stored so as to correspond to the selected ultrasound image.
